(19) United States
(12) Patent Application Publication
(10) Pub. No.: US 2025/0049127 A1
(43) Pub. Date: Feb. 13, 2025

(54) APPARATUS FOR HEATING AEROSOL-GENERATING MATERIAL

(71) Applicant: Nicoventures Trading Limited, London (GB)

(72) Inventor: Juan Esteban Paz JAUREGUI, London (GB)

(21) Appl. No.: 18/721,378

(22) PCT Filed: Dec. 20, 2022
(86) PCT No.: PCT/EP2022/087092

§ 371 Date: Jun. 18, 2024

(30) Foreign Application Priority Data
Dec. 20, 2021 (GB) 2118544.2

(51) Int. Cl. A24F 40/46; A24F 40/51; H05B 3/26

(52) U.S. Cl. CPC A24F 40/46; A24F 40/51; H05B 3/26

(57) ABSTRACT

An aerosol provision device including a receiving section for receiving a consumable; and a support element configured to retain an aerosol generator relative to the receiving section, wherein the support element includes a surface; and at least one means for retaining the aerosol generator away from the surface of the support structure.

### RELATED APPLICATIONS

The present application is a National Phase entry of PCT Application No. PCT/EP2022/087092 filed Dec. 20, 2022, which claims priority to GB Application No. 2118544.2 filed Dec. 20, 2021, each of which is hereby incorporated by reference in their entirety.

### TECHNICAL FIELD

The present invention relates to an apparatus arranged to heat aerosol-generating material.

### BACKGROUND

Aerosol-provision systems generate aerosol an inhalable aerosol or vapor during use by releasing compounds from an aerosol-generating-material. These may be referred to as non-combustible smoking articles, aerosol generating assemblies, or aerosol provision devices, for example.

### SUMMARY

In accordance with some embodiments described herein, there is provided an aerosol provision device comprising:
a receiving section for receiving a consumable;
an aerosol generator configured to provide heat to the receiving section; and
a support element configured to retain the aerosol generator relative to the receiving section, wherein the support element comprises:
a surface; and
at least one means for retaining the aerosol generator away from the surface of the support structure.

The aerosol provision device may further comprise the aerosol generator, wherein the aerosol generator may be configured to provide heat to the receiving section.

Therefore, In accordance with some embodiments described herein, there is provided an aerosol provision device comprising:
a substantially cylindrical receiving section for receiving a consumable article;
an aerosol generator configured to provide heat to the receiving section; and
a substantially cylindrical support element radially outwards of the first wall, the support element configured to retain the aerosol generator relative to the receiving section.

Additionally or alternatively to any of the embodiments above, there may be provided a plurality of means for retaining the aerosol generator extending from the surface of the surface of the support element such that there may be defined at least one gap between the surface of the support structure and the aerosol generator.

Additionally or alternatively to any of the embodiments above, the device may comprise at least one temperature sensor in the gap, and/or at least one connector in the gap, and/or insulation material in the gap.

Additionally or alternatively to any of the embodiments above, the at least one means for retaining the aerosol generator of the support structure may comprise a different material than the surface of the support structure.

Additionally or alternatively to any of the embodiments above, the receiving section may be substantially flat.

Additionally or alternatively to any of the embodiments above, the receiving section and the support structure may substantially cylindrical. The support element is positioned radially outward of the aerosol generator.

In accordance with some embodiments described herein, there is provided an aerosol provision device comprising:
a substantially cylindrical receiving section for receiving a consumable article;
a substantially cylindrical support element radially outwards of the receiving section, the support element configured to retain an aerosol generator relative to the receiving section.

The aerosol provision device may further comprising the aerosol generator, and the aerosol generator may be configured to provide heat to the receiving section.

Therefore, in accordance with some embodiments described herein, there is provided an aerosol provision device comprising:
a substantially cylindrical receiving section for receiving a consumable article;
an aerosol generator configured to provide heat to the receiving section; and
a substantially cylindrical support element radially outwards of the receiving section, the support element configured to retain the aerosol generator relative to the receiving section.

Additionally or alternatively to any of the embodiments above, the support structure may be omega shaped.

Additionally or alternatively to any of the embodiments above, the aerosol generator may comprise a resilient material such that the aerosol generator biases against the support element, retaining the aerosol generator in position.

Additionally or alternatively to any of the embodiments above, the aerosol generator may comprise FeCr alloy.

Additionally or alternatively to any of the embodiments above, the aerosol generator may be retained relative to the support structure by at least one attaching means.

Additionally or alternatively to any of the embodiments above, the attaching means may be a fastening means and/or a clamping means.

Additionally or alternatively to any of the embodiments above, a first wall can be disposed between the aerosol generator and the receiving section.

Additionally or alternatively to any of the embodiments above, the support element may comprise a plastics and/or a ceramics material.

Additionally or alternatively to any of the embodiments above, the support element may comprise a first portion and a second portion that are moveable relative to one another between a first position and a second position.

The first portion and the second portion may be connected about an axis such that they can rotate relative to one another between the first position and the second position.

Additionally or alternatively to any of the embodiments above, the support element may comprise a reflective material or coating configured to reflect heat towards the receiving portion.

Additionally or alternatively to any of the embodiments above, the support structure may comprise at least one connector portion through which a connector may pass such that the connector may be retained in position relative to the support element and the aerosol provision device.

Additionally or alternatively to any of the embodiments above, the support element may comprise at least one installation portion through which the aerosol generator extends.

Additionally or alternatively to any of the embodiments above, the aerosol generator may be a first aerosol generator configured to provide heat to a first receiving section; and the aerosol provision device may comprise a second aerosol generator configured to provide heat to a second receiving section.

There may be a second support element configured to retain the second aerosol generator relative to the second receiving section.

### BRIEF DESCRIPTION OF THE DRAWINGS

Embodiments of the invention will now be described, by way of example only, with reference to accompanying drawings, in which:

FIG. 1A shows a cross section of an example of an apparatus for heating an aerosol-generating material.

FIG. 1B shows a cross section along line B-B of FIG. 1A.

FIG. 2 shows an example flat heater arrangement for use in an apparatus for heating an aerosol-generating material.

FIG. 3 shows an example omega shaped support structure for supporting a aerosol generator of an apparatus for heating an aerosol-generating material.

FIG. 4 shows an example substantially cylindrical support structure for supporting a aerosol generator of an apparatus for heating an aerosol-generating material.

FIG. 5A shows a cross section of an example of an apparatus for heating an aerosol-generating material with a support structure retaining the aerosol generator.

FIG. 5B shows perspective view of an example support structure.

FIG. 6 shows an example support structure for supporting a flat heater arrangement for use in an apparatus for heating an aerosol-generating material.

FIG. 7A shows an example hinged support structure.

FIG. 7B shows a detail of the example support structure.

FIGS. 8A to 8D show an example assembly using a hinged support structure.

FIG. 9 shows an example aerosol generator within a support structure.

FIG. 10 shows another example structure with a consumable within the receiving section.

FIG. 11 shows another example support structure.

### DETAILED DESCRIPTION

Apparatus that heats aerosol-generating material to volatilize at least one component of the aerosol-generating material, typically to form an aerosol which can be inhaled, without burning or combusting the aerosol-generating material is sometimes described as a “heat-not-burn” apparatus or a “tobacco heating product” or “tobacco heating device” or similar. Similarly, there are also so-called e-cigarette devices, which typically vaporize an aerosol-generating material in the form of a liquid, which may or may not contain an active substance, such as nicotine. Of course, the apparatus may be configured to heat any aerosol-generating material, including non-tobacco products.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use.

The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

Whilst the examples herein may be shown with a circular cross section, and may be described with reference to “circumferential” walls, or other terminology relating to circles and cylinders, it would be appreciated that these could have any cross section, and the teachings herein are equally applicable to any shaped device and their respective perimeters. For example, the walls may instead have a square cross section, or equally any other regular, or irregular shape. Additionally, the support structures considered herein could equally be applied to flat aerosol generators, such as aerosol generators that are configured to heat flat consumables.

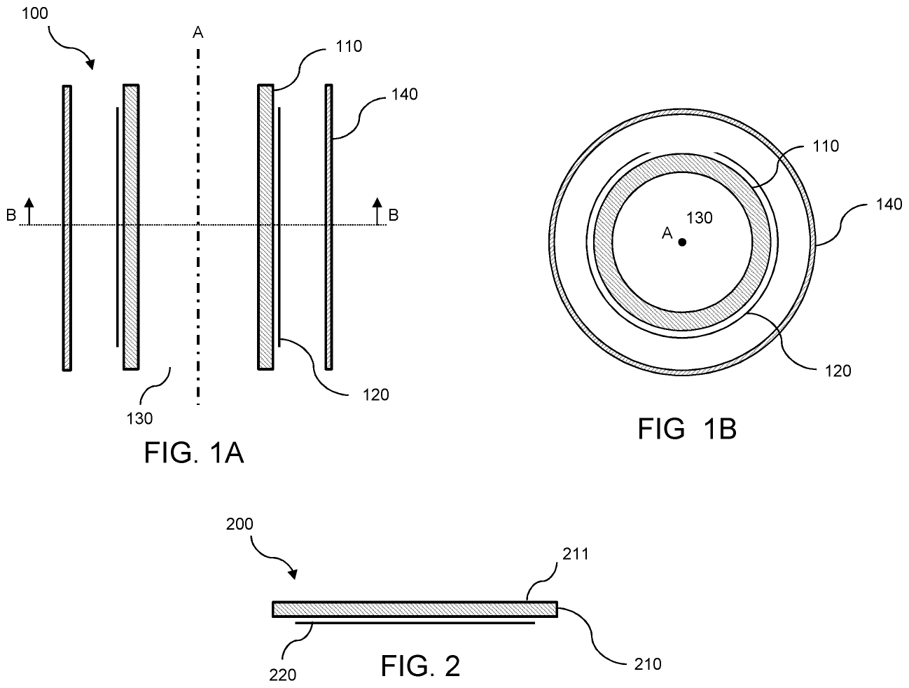

FIG. 1A shows a cross section of an example of an apparatus for heating an aerosol-generating material, shown generally as 100. The apparatus 100 may include a receiving section 130 for receiving a consumable article (not shown) to be heated, a first circumferential wall 110 that defines the receiving section 130, a second circumferential wall 140 that surrounds the first circumferential wall 110. As shown in FIG. 1, the first circumferential wall 110 is spaced apart from the second circumferential wall 140. In this way, the first circumferential wall 110 may be defined as a circumferential wall of an oven configured to heat a consumable article placed within.

In the examples herein, the first circumferential wall 110 may be heated by aerosol generator 120, which in the example of FIGS. 1A and 1B, is a sheet that is wrapped around the first circumferential wall. Advantageously, the first circumferential wall may protect the aerosol generator 120 from damage by insertion of the consumable. This is particularly beneficial where the aerosol generator 120 is made from a fragile material.

However, as would be appreciated, circumferential wall 110 may not be a separate entity. In this way, the aerosol generator 120 may define the oven, and therefore the receiving section 130 itself, being configured to directly receive the consumable article without an intervening structure. In this way, the aerosol generator 120 may directly heat the receiving section 130, thereby providing more efficient heating to a consumable received therein.

FIG. 1B shows a cross section along line B-B of FIG. 1A. As can be seen, the aerosol generator 120 may extend at least substantially around the first circumferential wall, and thereby any consumable article that is received therein.

The aerosol generator 120 may be heated in any suitable manner. For example, aerosol generator 120 may be a resistive aerosol generator, which may heat up when a current is passed through it.

Alternatively, the aerosol generator 120 may be an inductive aerosol generator (such as a susceptor), configured to generate heat in the presence of a magnetic field.

As mentioned above, the teaching herein is not limited to only cylindrical devices. For example, a device may have a square cross section, or any other regular or irregular cross section. Alternatively, the device may be configured to receive flat, or substantially flat consumables, for example as in device 200 of FIG. 2. In this case, the first wall 210 may provide a flat receiving section 211, upon which a consumable may be placed. The wall may be heated by a similarly shaped aerosol generator 220. Again, the first wall need not be a separate entity, but rather the aerosol generator could be considered to receive a consumable article directly thereon.

Surrounding, or forming, the second circumferential wall 140 may be an insulating member. For example, the insulating member may include an inner circumferential wall that forms the second circumferential wall.

The aerosol generators provided herein may be provided in the form of a flexible sheet, and therefore, may not be well matched to the desired shape of the receiving section. For example, the aerosol generator may comprise a metal material; for example, the aerosol generator may include one or more of: aluminum, copper, manganin, steel, constantan, nichrome, stainless steel, nickel and fecralloy (RTM). Such sheets may have a degree of resilience when bent such that they cannot simply be folded to the desired shape, as they may spring back open when released. As such there may be a need to retain aerosol generators in position within a device such that they provide good thermal contact with the first wall/oven, and/or retain a suitable shape such that they accurately define a receiving section themselves.

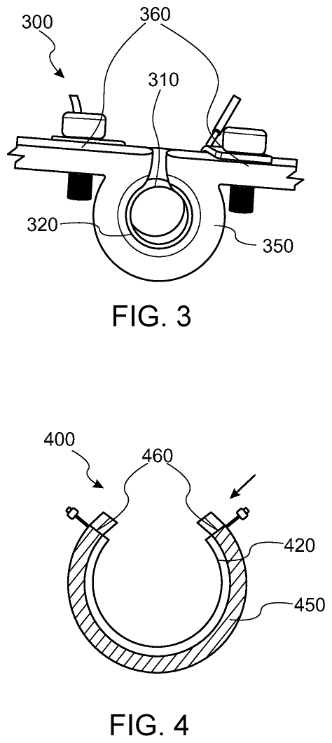

As such, a rigid support structure may be provided with the aerosol generator. For example, as shown in FIG. 3, the aerosol generator 300 is provided with a support structure 350 to stop the aerosol generator from springing open, thereby retaining the aerosol generator 320 in good contact with the first wall 310, which defines a portion in which a consumable may be placed. Of course, as discussed above, first wall 310 may also not be present, in which case, the support structure 350 retains the aerosol generator 320 in a suitable shape such that it defines a receiving portion itself.

Support structure 350 may be omega “Ω” shaped, i.e. in a circular shape (within which an oven may sit), with two flat portions 360 extending outwards from an open portion of the circle. In this way, the aerosol generator 320 may be configured to sit mainly within the circular shape of the support structure 350, and may then be secured to the support structure at the flat portion of the omega. Advantageously, such an arrangement may make use of the natural resilience of the material of the aerosol generator 320, as when the aerosol generator is radially surrounded, the outward spring helps to retain the aerosol generator 320 in shape. When an aerosol generator is retained by such a support structure, it may then accurately fit to an oven (such as the first circumferential wall of FIGS. 1A and 1B) that may be placed inside the support structure. Such an arrangement would keep the aerosol generator tight to the inside of the support structure, whilst also protecting the aerosol generator.

Furthermore, the provision of such an omega shape allows for the aerosol generator 320 to be secured at the flat portions 360 by attaching members that extend through the support structure 350 and the aerosol generator 320. Additionally, in the case where the aerosol generator 320 is a resistive aerosol generator, the attaching members may act as terminals, allowing a power source (not shown) to be electrically connected to the aerosol generator 320.

A similar arrangement for an aerosol generator 400 is shown in FIG. 4, although the support structure 450 is an open cylindrical shape, or is “C” shaped. Optionally, the aerosol generator 420 may be retained in the support structure 450 only by means of its natural resilience. Alternatively, the aerosol generator 420 may be connected to the support structure 450 by attaching members at portions 460, which may be flat. As above, the attaching members may additionally act as terminals, allowing the aerosol generator 420 to be connected to a power source.

Attaching elements 360 can be any kind of suitable attaching elements. As shown in FIG. 3, they may be provided in the form of a fastener, for example by means of a screw and/or a bolt, optionally with a corresponding nut. Additionally or alternatively, they could be a clamping arrangement, as shown in FIG. 4. Additionally or alternatively, the aerosol generator may be retained relative to the support structure (and the first wall) by way of its natural resilience which biases the aerosol generator against the support structure, thereby holding it in place.

As would be appreciated, the aerosol generator arrangements of FIGS. 3 and 4 may be provided in a general device arrangement shown in FIGS. 1A and 1B. In this way, the elements in the aerosol generator 300 and 400 may replace the like elements in FIGS. 1A and 1B. Equally, the support may be provided in a flat arrangement, such as that of FIG. 2, and may be configured to provide a clamp/coil structure to support a flat aerosol generator.

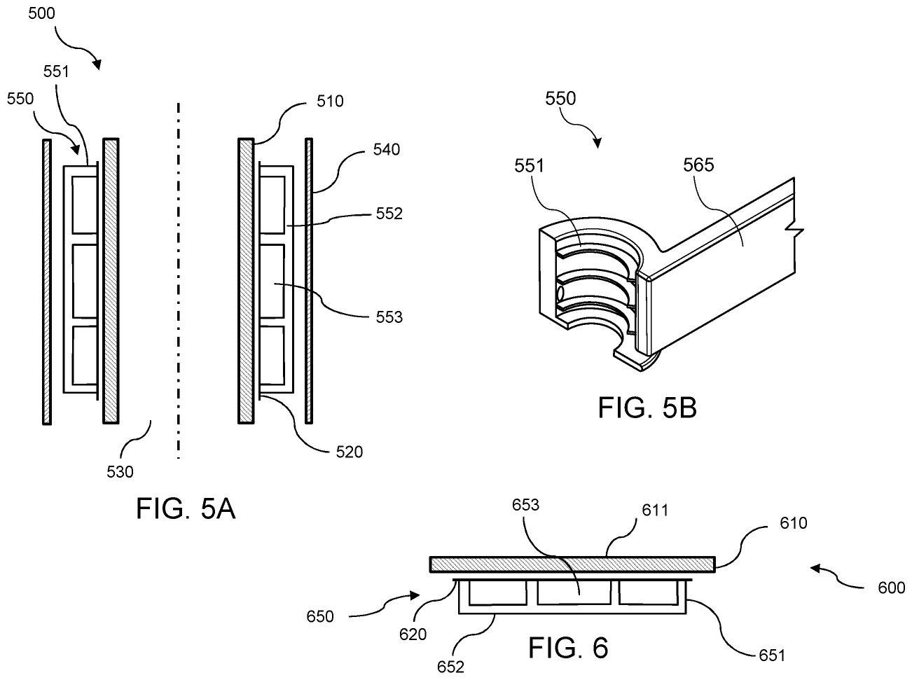

In further examples, the support structure may be provided with means for retaining the aerosol generator away from the surface of the support structure. For example, the support structure may be provided with fins which extend transversely from a surface of the support to retain the aerosol generator away from the surface of the support structure, as shown in FIGS. 5A, 5B and 6.

As would be appreciated, any means that retains a distance between the aerosol generator and the surface of the support could be utilized. For example, the means may comprise any structure that extends transversely from the surface, such as a plurality of columns or other supports distributed along the length and/or width of the support. In the case where the means are fins, then it would be appreciated that the fins may not need to extend across the whole length and/or width of the support. Rather, a plurality of fin like shapes may be provided.

In this way, whilst the means illustrated in FIGS. 5A, 5B and 6 are fins and may be described as such, it would be appreciated that the teaching below is applicable to any such means that provides the function of retaining the aerosol generator away from a surface of a support structure, thereby minimising the contact (and any potential heat loss) between the support and the aerosol generator, whilst robustly maintaining the aerosol generator in position.

Additionally, whilst the means for retaining the aerosol generator is illustrated herein as an integral part of the support structure, it would be appreciated that the retaining means may be a separate component that provides the function of holding the aerosol generator spaced apart from a surface of the support.

FIG. 5A shows a cross section of an example of an apparatus for heating an aerosol-generating material, shown generally as 500. The apparatus 500 may include a receiving section 530 for receiving a consumable article (not shown) to be heated, a first circumferential wall 510 that defines the receiving section 530, a second circumferential wall 540 that surrounds the first circumferential wall 510. As shown in FIG. 1, the first circumferential wall 510 is spaced apart from the second circumferential wall 540. In this way, the first circumferential wall 530 may be defined as a circumferential wall of an oven configured to heat a consumable article placed within.

In the examples herein, the first circumferential wall 510 may be heated by aerosol generator 520, which in the example of FIG. 5A, is a sheet that is substantially surrounds the first circumferential wall 510. However, as would be appreciated, circumferential wall 510 may not be a separate entity. In this way, the aerosol generator 520 may define the oven, and therefore the receiving section 530 itself, being configured to directly receive the consumable article without an intervening structure.

As in the examples of FIGS. 3 and 4, in order to retain the aerosol generator 520 in position, the apparatus 500 is provided with a support structure 550. As can be seen in the example of FIG. 5B, which shows a perspective view of a support element 550, the support element 550 may form at least in part a substantially cylindrical shape, in which the aerosol generator 520 may be retained in position. In the example of FIG. 5B, the support element is in an Omega “Ω” shape, similar to that of FIG. 3, with flat portions 565 extending therefrom. As would be appreciated, the support element may also be in a substantially cylindrical shape, similar to the arrangement of FIG. 4.

As would be appreciated by the skilled person, the term “substantially cylindrically shaped” designates any shape which comprises at least in part a cross section that is at least semi-circular or partially circular. For example, the cross section of FIG. 3 would be considered substantially cylindrically shaped, as the cross section of the round part of the omega defines the majority of a circle. Similarly, the “open” cylinder, or “C” shape of FIG. 4 would be considered substantially cylindrical, as its cross section again defines the majority of a circle. Of course, a substantially cylindrical cross section also covers a cylindrical cross section.

As mentioned above, the teaching herein is not limited to only cylindrical devices. For example, a device may have a square cross section, or any other regular or irregular cross section. Alternatively, the device may be configured to receive flat, or substantially flat consumables, for example as in device 600 of FIG. 6. In this case, the first wall 610 may provide a flat receiving section 611, upon which a consumable may be placed. The wall may be heated by a similarly shaped aerosol generator 220. Again, the first wall 610 need not be a separate entity, but rather the aerosol generator could be considered to receive a consumable article directly thereon.

As in the examples of FIGS. 5A, 5B, and 6, the support structure 550, 650 with retaining means 551, 651 which extend from a surface 552, 652 of the support to retain the aerosol generator away from the surface of the support structure. Such a structure limits heat leaching from the aerosol generator 520, 620 into the support structure, as the contact between the aerosol generator and the support structure is minimised by the retaining means. In addition, the retaining means may be configured to direct generated heat towards the consumable that is received in the receiving portion. This improves the efficiency of the aerosol generator 520, 620 in heating the consumable element that is to be received by the device.

In addition, retaining means 551, 651 provide gaps 553, 653, which create pockets of air between the aerosol generator 510, 610 and the surface 552, 652 of the support structure, which further helps to insulate the support structure from the aerosol generator. Additionally, or alternatively, the gaps 553, 653 may be provided with a separate insulating material (for example, glass fiber and/or aerogels), and/or other components such as one or more temperature sensor(s), and/or allow connectors to pass through.

Whilst there are no retaining means show in FIG. 5A, 5B or 6, it would be appreciate that any such retaining means may be utilized. For example, fasteners may be used on the flat portions 565 to retain aerosol generator in place. Additionally or alternatively, a clamping arrangement similar to FIG. 4 may be used. Additionally or alternatively, the aerosol generator may be retained by its natural resilience, biasing the aerosol generator against the support structure, thereby holding the aerosol generator in place relative to the support structure and the first wall.

The support structures discussed above may be made of any suitable material. In some embodiments, the support structure may be made of a plastics material capable of withstanding temperatures necessary to volatize one or more components of the aerosol-generating material.

For example, the support structure may comprise polyether ether ketone (PEEK). Additionally or alternatively, the support structure may comprise one or more ceramic materials. For example, at least the retaining means may be made of a ceramic material that can withstand the high temperatures reached by the aerosol generator.

Additionally, it may be beneficial that the support structure and the means for retaining the aerosol generator be made of a material that has a low thermal conductivity, thereby limiting the amount of heat that may be absorbed within the support and retaining means away from the aerosol generator, and the receiving section. For example, the support structure and the means for retaining the aerosol generator be made of a material that has a thermal conductivity of less than 0.1 W/mK.

Additionally or alternatively, the surface of the support structure may be coated with a suitable material. For example, the surface 552, 652 may be coated on its inside (i.e. the surface that faces the aerosol generator) with a reflective material, such that any heat that is radiated from the outside of the aerosol generator away from the receiving section is reflected back towards the receiving section. For example, a ‘reflective coating’ may mean that the coating has an emissivity of 0.15 or less (i.e. 15% of energy from radiation received by the coating at a 90 degree angle is absorbed and the rest is reflected).

Whilst in the illustrated embodiments, the means for retaining the aerosol generator are generally shown as fins that extend from a surface of the support with constant cross section, it would be appreciated that they may be of any shape. In addition, the cross section may reduce as the retaining means extends towards the aerosol generator, so as to reduce the total amount of contact between the aerosol generator and the retaining means, thereby reducing heat loss. In the examples of FIGS. 5A, 5B and 6, the fins may therefore be of a triangular/trapezoidal cross section.

The retaining means and/or the entirety of the support may be hollow, thereby reducing the weight, and thermal mass of the support and retaining means, limiting heat loss.

Advantageously, the retaining means may act as shock absorbing members. For example, if the device is dropped, then the retaining means can reduce the transmission of shock forces to the oven and/or the aerosol generator, which may be fragile and prone to breaking.

The support structure may be provided as a single piece of material, in which the remaining items (e.g. an oven and an aerosol generator) may be placed. For example, an aerosol generator may be introduced into the receiving section, and then the natural resilience of the material may bias the aerosol generator against the support member, so as to retain the aerosol generator in place. Alternatively, for example, where the support member is in the shape of an omega, the support structure may be introduced in a gap in the support member.

Alternatively, the support structure can be provided in more than a single piece, in order to facilitate easier manufacturing of the support structure, and/or easier installation of other parts of the device. For example, the support structure may be provided in several separate parts that may be installed together. These separate parts may be constructed from an “open” configuration, to a closed configuration for use. For example, the support structure may be provided as several separate pieces that can removable be fitted together. In the closed configuration, the support structure may provide any suitable shape for retaining the aerosol generator in fixed relation with the receiving section and/or oven. For example, in the closed configuration, the support structure may form an omega, cylindrical or flat configuration as discussed above. Equally, the support structure could be provided in any other suitable shape.

Additionally/alternatively, the support structure and the retaining means may be provided separately, and so the retaining means can be fitted on to the support structure. In this way, the retaining means may be replaceable and/or customisable depending on their desired function. For example, the retaining means may be replaced with retaining means of a different material and/or shape, depending on its desired properties. This allows for a more modular design of apparatus, whereby each component may be chosen and/or replaced as necessary.

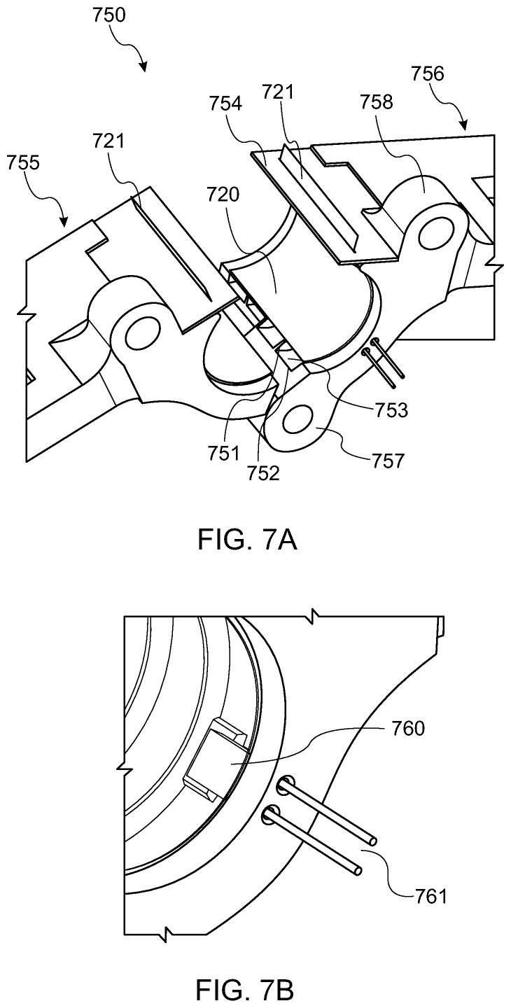

One example of a support structure comprising multiple parts is shown in FIGS. 7A and 7B, wherein the support structure 750 is in the form of a hinged structure that facilitates easy opening and closing of the support structure. In these examples, the closed configuration has an omega shape, as described above, although it would be appreciated that the support structure may have any desired shape for use. The opening and closing may allow for easier installation of the aerosol generator and/or an oven (also referred to as a first wall in the examples of FIGS. 1A, 1B, 2 and 3). Additionally or alternatively, the opening may allow for an easy introduction of a consumable into the receiving section.

Referring to FIG. 7A, the support structure 750 comprises first and second portions 755, 756, which, in use, are configured to fit together. For example, each portion may comprise an attachment means 757, which is configured to interact with an attachment means on the other of the two portions, such that the portions may be attached to one another. In the example of FIG. 7A, the attachment means of each of the first and second portions is in the form of a portion through which a separate fastener (not shown) may be introduced, thereby securing the first and second portions 755, 756 together. Advantageously, such a fastener may act as an axis about which the first and second portions 755, 756 may pivot, thereby allowing the first and second portions 755, 756 to be moved relative to one another between an open and a closed position, whilst being retained together. In this way, even when in the “open” position, the amount of separate, loose parts is kept to a minimum, thereby facilitating easier installation.

As can be seen, each of the first and second portions 755, 756 is provided with an installation portion 754, which comprises an introductory portion (e.g a hole or slot) through which the aerosol generator 720 may be introduced to the support structure. The introductory portion may be sized and shaped so as to closely correspond to the cross section of the aerosol generator 720, such that, when the aerosol generator is in place, it may be retained by the introductory portion by way of an interference fit. Alternatively, the introductory portion may be a clearance fit with regards to the aerosol generator 720, such that the aerosol generator may easily pass through the installation portion 754, so as to avoid damage of the aerosol generator. In such a case, the aerosol generator 720 may be retained by other means with relation to the support 750, if necessary.

In the case of FIG. 7A the introductory portion is in the form of a slot, and the aerosol generator 720 is in the form of a sheet. Of course, these may be provided in other arrangements, depending on the shape/requirement of the aerosol generator. For example, if the aerosol generator is in the form of a round wire that is to be wrapped around the receiving portion, the introductory portion may be in the form of a plurality of holes, each shaped such that they can receive the aerosol generator passing through. Alternatively, the introductory portion may remain as a slot, and the wire passed through the introductory portion several times. Of course, a similar installation portion/introductory portion arrangement may be found in cases where the support structure is a single piece, such as the Examples of FIGS. 3 to 6.

Advantageously, by providing the aerosol generator 720 through the introductory portions, there is provided a portion of the aerosol generator that is free for other connections. For example, a connector may be connected to the portion 721 of the aerosol generator 720 that extends beyond the installation portion 754. Such a connector may be passed through a connector portion 758 on the respective one of the first/second 755, 756 portions, so as to connect to the respective end of the aerosol generator. Again, the connector portion 758 may be provided such that a connector that is fed therethrough has an interference fit with the connector portion 758. In this way, when fitted, the connector may be retained by its fit with the connector portion, such that if the connector is pulled, the connector portion may retain the connector in place. In this way, the connector portion 758 way act as a stress relieving portion, as any force that is applied externally to a connector that is provided therethrough may be exerted on the connector portion 758, rather than being transferred through the connector to the connection between the connector and the aerosol generator, which may be fragile.

In the example of FIG. 7A, the aerosol generator 720 is shown in two parts, showing the shape of the internal surface of the support structure 750, with retaining means 751 extending from the surface 752, thereby providing gaps 753 between the aerosol generator 720 and the support structure. Of course, the aerosol generator may be provided as on single, continuous sheet, which facilitates easier installation. Alternatively, the aerosol generator may be provided in two or more portions (as seen in FIG. 7A), that are connected when the support structure is provided in the closed configuration. This may prevent damage to the aerosol generator during opening/closing of the support structure.

As may be seen in FIG. 7A, the support is provided in an open configuration. As would be appreciated, the support structure may be opened further so as to provide more of a gap through which an oven/first wall and/or a consumable may be introduced.

Also shown in FIG. 7A, and in more detail in FIG. 7B (where the aerosol generator is shown as being transparent for clarity reasons, the support structure (and specifically the gaps 753) may provide space for further components. For example, the gap 753 may provide space for a further component 760, with connectors 761 that can pass through the support structure. For example, component 760 may be a temperature sensor that can monitor the temperature of the aerosol generator, and provide a sensed temperature to external components through connectors 761. Such a temperature may be monitored to ensure that the temperature of the aerosol generator may be reaching a desired level, or equally, that the aerosol generator is not dangerously hot. Such a temperature sensor may improve the reliability or safety of an aerosol provision device. Of course, whilst there is only a single component 760 shown in the example of FIG. 7B, there may be multiple components provided therein. Equally, there may be no components provided therein. As discussed above, the gaps may additionally or alternatively filled with an insulating material and/or insulating fluid.

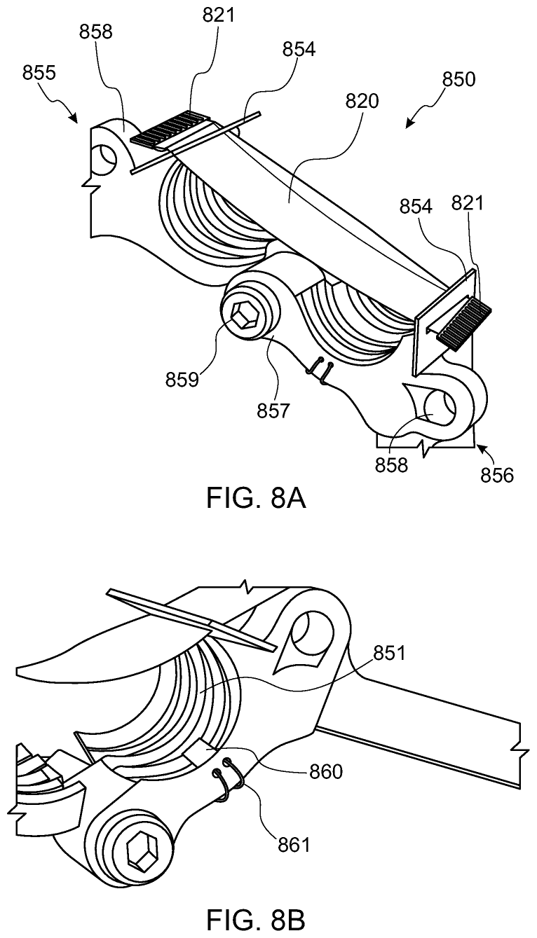

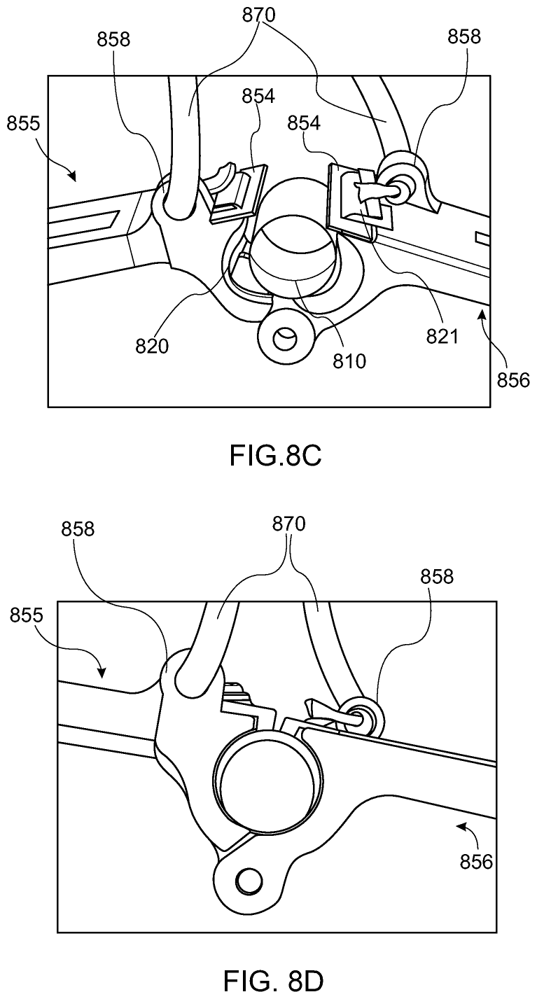

FIGS. 8A to 8D show an example assembly process of a support structure, such as the hinged structure shown in FIGS. 7A and 7B. The reference numerals in these figures reflect the reference numerals of FIGS. 7A and 7B, with like reference numerals indicating like features.

FIG. 8A shows a hinged support structure 850 in the open position with an attached aerosol generator 820. FIG. 8B shows an alternate view of the open position of the support structure, so as to more clearly show the component 860 and the retaining means 851. Of course, whilst the retaining means 851 are shown in this example as fins, as discussed above, they may be any shape. Alternatively, there may be no retaining means 851, but rather the aerosol generator 820 may merely lie on a surface of the support structure.

As can be seen, the support structure 850 For comprises first portion 855 and second portion 856 attached together through their respective attachment means 857, which are provided with a fastener 859 therethrough, which acts as a pivot such that the first and second portions can move relative to one another. As can be seen, in the open position, it may be easier to introduce the aerosol generator 820 through the installation portions 854, which reduces the chance of breaking the aerosol generator 820, which may be fragile. Then, once the aerosol generator is in position, then the support structure 850 may be moved to the closed position. With such a position, the natural resilience of the aerosol generator may push the aerosol generator radially outwards such that it contacts the retaining means 851 of the support structure, and therefore forms a desired shape, defining a receiving portion and/or a space for an oven/first wall therein.

The process of closing the support structure 850 so as to provide the aerosol generator 820 around a first wall/oven 810 may be seen in FIGS. 8C and 8D. Advantageously, by providing first wall/oven 810 within the support structure 850, the first wall 810 may encourage the aerosol generator 820 to more tightly fit to the support structure and any retaining means that are provided therein. Such a first wall/oven 810 more accurately defines a receiving portion for receiving a consumable, which may protect the aerosol generator 820 from damage.

As seen in FIG. 8C, the first wall/oven 810 may be placed on the aerosol generator 820, and the first and second portions of the support structure 855, 856 then may be moved into the closed position, thereby securing the first wall/oven 810 and the aerosol generator 820 in position.

Also shown in FIGS. 8C and 8D is the arrangement between connectors 870, the connector portions 858 and the portion of the aerosol generator 821 that extends through the installation portion 854. The connectors 870 are passed through a connector portion 858 on the respective one of the first/second 855, 856 portions, and then are connected (in this case, by a solder, although any connection may be provided) to the ends of aerosol generator 821.

As describe above, when fitted, the connector may be retained by its fit with the connector portion, such that if a force is applied to the connector at its distal end (i.e. an end away from the aerosol generator), the connector portion 858 may retain the connector in place. In this way, the connector portion 858 way act as a stress relieving portion, as any force that is applied externally to a connector that is provided therethrough may be exerted on the connector portion 858, rather than being transferred through the connector 870 to the connection between the connector and the aerosol generator, which may be fragile. This results in a more robust aerosol generating device.

Once in the closed position (i.e. a position in which the aerosol generating device may be used), then the first and second portions of the support structure 855, 856 may be fixed relative to one another. The fixing may be permanent or semi-permanent (e.g. by a weld, adhesive, or otherwise). This retains maximum strength in support, thereby improving the robustness of the device. Alternatively, the fixing may be temporary (e.g. by way of a clip, or otherwise), allowing the support structure to be opened and closed, when necessary. This may facilitate more convenient use of the aerosol generating device, as the first wall/oven 810 may be removed/cleaned if necessary, as may the aerosol generator.

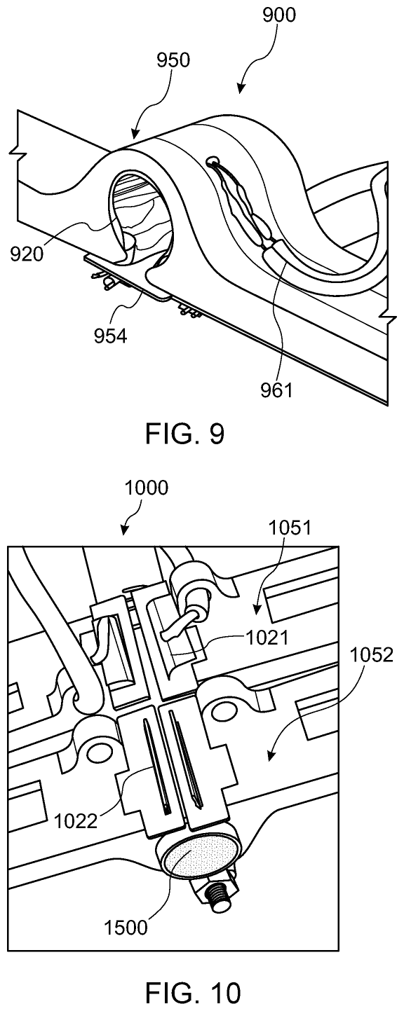

An example constructed apparatus 900 for heating an aerosol-generating material is seen in FIG. 9. As can be seen, the apparatus 900 comprises a single pieced support structure 950, as described above. FIG. 9 shows an example without a separate first wall/oven, and therefore the receiving portion is defined solely by the inner surface of the aerosol generating material 920. The absence of a separate first wall/oven means that heat generated by the aerosol generator is provided directly to a consumable received within the receiving portion, which can result in faster and more efficient heating. The apparatus 900 may otherwise comprise any of the features that are shown in FIGS. 8A to 8D, for example, an additional component(s), utilizing connectors 961. Whilst it cannot be seen in FIG. 9, the aerosol generator 920 may be provided through an introductory portion (e.g. a hole or slot) through the installation portion 954, wrapped around the internal surface of the support structure 900, and then provided though a similar introductory portion (e.g a hole or slot) in the installation portion 954 on the other side of the opening at the top of the omega. Alternatively, a single installation portion may be provided across the entire gap of the omega, with two separate introductory portions, such that the aerosol generator may be provided through one, and out of the other.

As shown in FIG. 10, an apparatus 1000 for heating an aerosol-generating material may comprise a first and a second aerosol generator 1021, 2022. Each aerosol generator 1021, 1022 may each be provided with a corresponding support structure 1051, 1052. Equally, each aerosol generator 1021, 1022 may be provided in the same support structure. As would be appreciated, each aerosol generator defines their own receiving section within which a consumable may be placed. The receiving sections may be aligned such that the aerosol generators are arranged so as to heat the same consumable 1500, such as the one shown in FIG. 10, or equally they may be arranged such that they receive separate consumables in their own receiving sections.

Each support structure and aerosol generator may be arranged as in any of the examples described above. Each aerosol generator and support structure may be similar, or they may be different, depending on their desired function. For example, it may be desired that a portion of consumable 1500 is heated quickly. In such a case, it may be beneficial for at least one of the aerosol generators to be provided without a first wall/oven structure between the consumable and at least one aerosol generator. If the first aerosol generator 1021 is provided without an oven, then it may be desirable for the second aerosol generator 1022 is provided with an oven, which can help to locate the consumable 1500 centrally in the apparatus 1000 such that, if the consumable is introduced to the apparatus 1000 first through the second aerosol generator 1022 and support structure 1052, then the consumable remains centered in the device it reduces the chance of the consumable coming into direct contact with and damaging the first aerosol generator, even though the first aerosol generator is provided without an oven.

Equally, it may be desired that different portions of the consumable(s) are heated at different times, in which case, the aerosol generators may provide heat at different times.

Of course, one or more components may be omitted from such an apparatus 1000. If an electrical connection is required to the aerosol generators (e.g. in the case of resistive heating), each aerosol generator 1021, 1022 may be connected to the same set of connectors. Equally, in the case where each of the support structures are hinged support structures, then they may be attached through their attachment portions by a single fastener.

Furthermore, an aerosol generator may not necessarily form part of any of the apparatus described above, but rather, could be formed as part of a consumable to be received by the apparatus. In this case, the retaining means may retain the consumable, which is internally heated. The retaining means would still provide the benefit of more efficient heating, as it would provide insulation to the consumable.

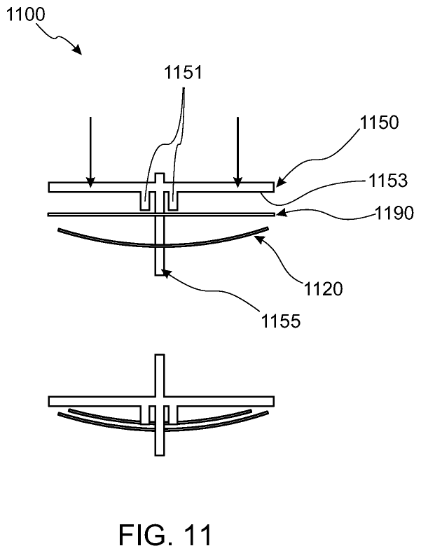

FIG. 11 shows another arrangement of an apparatus 1100 for heating an aerosol-generating material, with another example support structure 1150. In this arrangement, the receiving section is defined between the surface 1153 of the support structure 1150 and the aerosol generator 1120. In this way, a consumable 1190 may be placed between the surface of the support structure, and the aerosol generator. Further, the apparatus 1100 may further comprise a means 1155 to provide relative movement between the aerosol generator 1120 and support structure 1150, thereby moving the aerosol generator with respect to the surface 1153 of the support structure 1150. The means 1155 may form a part of the support structure 1150, or alternatively, may be a separate piece. In this way, in order to introduce a consumable 1190 into the apparatus 1100, the aerosol generator 1120 may be moved away from the support structure 1150 by means 1155. Then, the aerosol generator 1120 may be moved towards the support structure 1150 in order to hold the consumable 1190 in position relative to the aerosol generator 1120, for example by clamping the consumable 1190 between the support structure 1150 and the aerosol generator.

The support structure again may be provided with one or more retaining means 1151 configured to the retain the aerosol generator 1120 (and consumable 1190) away from the surface 1153 of the support structure. Advantageously, such an arrangement again provides the benefits discussed above, where the gap between the surface 1153 of the support structure 1150 and the aerosol generator 1120 insulates the support structure from the aerosol generator 1120. Additionally, such retaining means 1151 may be configured to ensure, in use, that the consumable 1190 matches to any shape of the aerosol generator 1120. This can be seen in the Example of FIG. 11, wherein the aerosol generator 1120 has a curved shape, yet the consumable 1190 normally has a flat shape. When the means 1155 for providing relative movement between the aerosol generator 1120 and the support structure 1150 brings the aerosol generator 1120 into contact with the retaining means 1151, with the consumable 1190 in between, the consumable bends to the shape of the aerosol generator 1120. In this way, the aerosol generator may more efficiently heat the consumable 1190. In order to aid this, the surface of the one or more retaining means 1151 that contacts the consumable 1190 may be shaped so as to substantially correspond with the shape of the aerosol generator.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a receiving section for receiving a consumable; and
a support element configured to retain an aerosol generator relative to the receiving section, wherein the support element comprises:
a surface; and
at least one means for retaining an aerosol generator away from the surface of the support structure.

2. The aerosol provision device of claim 1, wherein there are provided a plurality of means for retaining an aerosol generator extending from the surface of the support element such that there is defined at least one gap between the surface of the support structure and the aerosol generator.

3. The aerosol provision device of claim 2, further comprising at least one temperature sensor in the gap, and/or at least one connector in the gap, and/or insulation material in the gap.

4. The aerosol provision device of claim 1, wherein the at least one means for retaining an aerosol generator of the support structure comprises a different material than the surface of the support structure.

5. The aerosol provision device of claim 1, wherein the receiving section is substantially flat.

6. The aerosol provision device of claim 1, wherein the receiving section and the support structure are substantially cylindrical.

7. The aerosol provision device of claim 6, wherein the support element is positioned radially outward of the receiving section.

8. An aerosol provision device comprising:
a substantially cylindrical receiving section for receiving a consumable article;
a substantially cylindrical support element radially outwards of the receiving section, the support element configured to retain an aerosol generator relative to the receiving section.

9. The aerosol provision device of claim 8, wherein the support structure is omega shaped.

10. The aerosol provision device of claim 8, wherein the support element is configured to receive an aerosol generator comprising a resilient material such that, in use, the aerosol generator biases against the support element, retaining the aerosol generator in position.

11. The aerosol provision device of claim 8, wherein the support element comprises a plastics and/or a ceramics material.

12. The aerosol provision device of claim 8, wherein the support element comprises a first portion and a second portion that are moveable relative to one another between a first position and a second position.

13. The aerosol provision device of claim 12, wherein the first portion and the second portion are connected about an axis such that they can rotate relative to one another between the first position and the second position.

14. The aerosol provision device of claim 8, wherein the support element comprises a reflective material or coating configured to reflect heat towards the receiving portion.

15. The aerosol provision device of claim 8, further comprising the aerosol generator, wherein the aerosol generator is configured to provide heat to the receiving section.

16. (canceled)

17. The aerosol provision device of claim 15, wherein the aerosol generator is retained relative to the support structure by at least one attaching means.

18. (canceled)

19. The aerosol provision device of claim 15, further comprising a first wall disposed between the aerosol generator and the receiving section.

20. The aerosol provision device of claim 15, wherein the support structure comprises at least one connector portion through which a connector may pass such that the connector may be retained in position relative to the support element and the aerosol generator.

21. The aerosol provision device of claim 15, wherein the support element comprises at least one installation portion through which the aerosol generator extends.

22. The aerosol provision device of claim 15, wherein the aerosol generator is a first aerosol generator configured to provide heat to a first receiving section; and wherein
the aerosol provision device comprises a second aerosol generator configured to provide heat to a second receiving section.

23. (canceled)
